(19) United States
(12) Patent Application Publication
(10) Pub. No.: US 2025/0188820 A1
(43) Pub. Date: Jun. 12, 2025

(54) GEOTHERMAL POWER SYSTEMS AND METHODS FOR SUBSEA SYSTEMS

(71) Applicant: OneSubsea IP UK Limited, London (GB)

(72) Inventors: William Henderson, Houston, TX (US); Michael Larkin, Houston, TX (US)

(21) Appl. No.: 18/532,173

(22) Filed: Dec. 7, 2023

(51) Int. Cl. E21B 41/00; E21B 43/12

(52) U.S. Cl. CPC E21B 41/0085; E21B 43/121

(57) ABSTRACT

A system includes a subsea turbine power system having a turbine power plant configured to receive potential energy from a well fluid received from a hydrocarbon well, and convert the potential energy into at least one of electrical energy and mechanical energy. The system further includes a subsea equipment at least partially powered by at least one of the electrical energy and the mechanical energy produced by the subsea turbine power system, at least one valve configured to control flow of the well fluid through the turbine power plant, and a sensor configured to obtain sensor feedback of a pressure and/or a flow rate of the well fluid. The system further includes a controller having a processor, a memory, and instructions stored on the memory and executable by the processor to adjust the at least one valve to control the flow of the well fluid through the turbine power plant.

### BACKGROUND

The subject matter disclosed herein relates to one or more turbine power systems disposed in a subsea system.

A subsea system used for extracting hydrocarbons includes one or more electrically-powered subsystems, including a manifold, a tree, a pump station, and the like. These electrically-powered subsystems are conventionally electrically coupled to a power station, which is powered via one or more electrical cables (e.g., umbilical cables) that electrically couple the power station to a surface platform. Due to the amount of power that is transmitted through these electrical cables to the power station and the shielding used for protecting the electrical cables from the surrounding water, the manufacturing cost of these electrical cables is substantial. Additionally, due to the length of the cable and other factors, loss of power through the electrical cables is known to occur. Accordingly, a need exists for at least lowering the manufacturing cost of these electrical cables and mitigating the likelihood of loss of power transmission.

### SUMMARY

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In certain embodiments, a system includes a subsea turbine power system having a turbine power plant configured to receive potential energy from a well fluid received from a hydrocarbon well, and convert the potential energy into at least one of electrical energy and mechanical energy. The system further includes a subsea equipment at least partially powered by at least one of the electrical energy and the mechanical energy produced by the subsea turbine power system, at least one valve configured to control flow of the well fluid through the turbine power plant, and a sensor configured to obtain sensor feedback of a pressure and/or a flow rate of the well fluid. The system further includes a controller having a processor, a memory, and instructions stored on the memory and executable by the processor to adjust the at least one valve to control the flow of the well fluid through the turbine power plant.

In certain embodiments, a system includes a subsea turbine power system having a turbine power plant configured to receive potential energy from a well fluid received from a hydrocarbon well and convert the potential energy into at least one of electrical energy and mechanical energy, the turbine power plant including a plurality of turbines. The turbine power plant further includes a controller including a processor, a memory, and instructions stored on the memory and executable by the processor to control a distribution of the well fluid to the plurality of turbines.

In certain embodiments, a method includes receiving potential energy from a well fluid received from a hydrocarbon well. The method further includes converting the potential energy into at least one of electrical energy and mechanical energy in a turbine power plant of a subsea turbine power system. The method further includes at least partially powering a subsea equipment with at least one of the electrical energy and the mechanical energy.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of a subsea system, according to an embodiment of the present disclosure;

FIG. 2 is a schematic view of the subsea system of FIG. 1 having one or more turbine power systems, according to an embodiment of the present disclosure;

FIG. 3 is a schematic view of a turbine power plant of the turbine power system of FIG. 2, according to an embodiment of the present disclosure;

FIG. 4 is a schematic view of the turbine power system of FIG. 2 as a standalone unit, according to an embodiment of the present disclosure;

FIG. 5 is a schematic view of the turbine power system of FIG. 2 retrievably coupled to a portion of a production flow line, according to an embodiment of the present disclosure;

FIG. 6 is a schematic view of the turbine power system of FIG. 2 coupled to a subsea equipment as a packaged unit, according to an embodiment of the present disclosure; and

FIG. 7 is a flowchart of an example process for operating the turbine power system of FIG. 2, according to an embodiment of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening stations between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

The present disclosure is generally directed toward one or more one or more turbine power systems that are distributed throughout a subsea system that may be used to produce power for use by the subsea system and/or a surface platform. In particular, the disclosed embodiments may be used for powering one or more trees (e.g., Christmas tree, frac tree, production tree, etc.) coupled to one or more wells throughout the field (e.g., a hydrocarbon field), one or more field extensions, the controller, the pump station, the manifold, subsea boosting, subsea compression, pipe heating, or a combination thereof. In certain embodiments, power produced by the one or more turbine power systems may be sent to a surface platform via an electrical cable (e.g., umbilical cable). The turbine power system may include one or more turbines arranged in a parallel configuration and/or a series configuration. For example, in the parallel configuration, the one or more turbines may be fluidly coupled to one another in parallel. The one or more turbines may be configured to convert potential energy of a flow of well fluid into electrical and/or mechanical energy, which may be used to power one or more components of the subsea system.

In certain embodiments, the turbine power systems generate power continuously by using the excess energy (e.g., pressure) in the fluid flow after completion of a well, such that fluid flow is a production flow that continuously flows through the turbine power systems. For example, the turbine power systems generate power continuously to power various subsea trees, manifolds, pumps, compressors, valves, etc. without requiring power from a surface power source, and excess electricity may be stored in one or more energy storage units (e.g., batteries). Additionally, the fluid flow may be selectively routed through one or more of the turbine power systems to use the excess energy while still maintaining minimum pressures and/or minimum flow rates for the fluid to be routed to a surface location or other remote destination. In this manner, the turbine power systems may simultaneously generate power (e.g., electrical and/or mechanical power) in situ for power subsea equipment while also regulating the pressure and flow rate of the fluid (e.g., maintaining pressures and/or flow rates between upper and lower thresholds). In some embodiments, the turbine power systems generate power continuously using excess energy in other fluid flows, such as chemical injection fluid flows. In some embodiments, the turbine power systems generate power continuously may include or exclude applications prior to completion of wells. In some embodiments, the turbine power systems generate power continuously to provide at least 100, 200, 300, 400, or 500 watts of electricity for powering subsea trees, manifolds, etc.

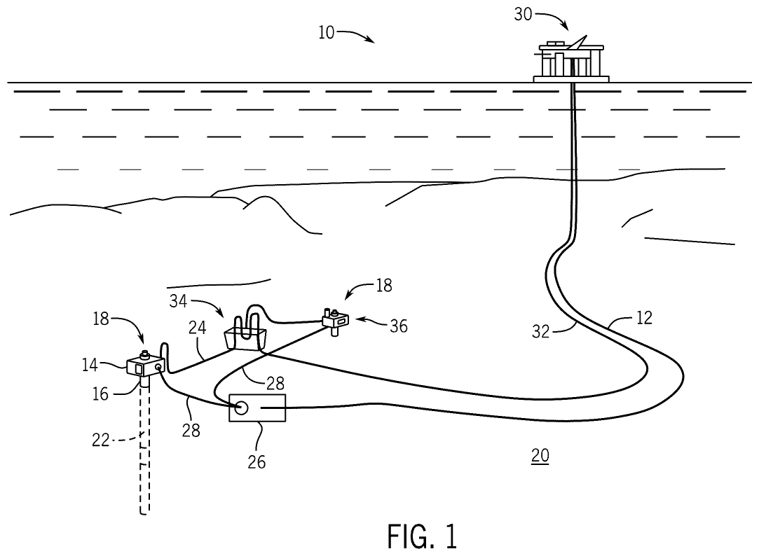

With the foregoing in mind, FIG. 1 is a schematic view of a subsea system 10 with electrical cables 12 (e.g., umbilical cables) used for transmitting information and primary electrical power for various subsea stations (e.g., actuators, sensors, etc.). The subsea system 10 may include a subsea hydrocarbon production system configured to extract oil or gas from a subterranean reservoir, a subsea fluid injection system configured to inject fluid (e.g., liquid or gas) into a subterranean reservoir, or any other subsea system associated with subterranean reservoirs. For example, the subsea fluid injection system may include a subsea gas, water, and/or carbon dioxide (CO₂) injection system. In certain embodiments, the subsea system 10 may include a subsea tree 14 coupled to a wellhead 16 to form a subsea station 18 configured to extract and/or inject fluids relative to a subterranean reservoir. In certain embodiments, the subsea tree 14 includes a Christmas tree having a set of valves, spools, and fittings connected to the top of a well to direct and control the flow of formation fluids from the well. An example of the Christmas tree is a production tree, which may be installed after completion of hydraulic fracturing. The subsea tree 14 may include a frac tree having upper and lower master valves, a flow cross, wing valves, a goat head, and a swap valve, wherein the frac tree is configured to facilitate hydraulic fracturing. However, the subsea tree 14 may include any type and configuration and trees. The subsea station 18 may be configured to extract formation fluid, such as oil and/or natural gas, from the sea floor 20 through the well 22. By further example, the subsea station 18 may be configured to inject CO₂ into the subterranean reservoir. In some embodiments, the subsea system 10 may include multiple subsea stations 18 that extract and/or inject fluids relative to respective wells 22.

In embodiments of the subsea system 10 configured for production, after passing through the subsea tree 14, the formation fluid flows through fluid conduits or pipes 24 to a manifold 26 (e.g., pipeline manifold or flowline manifold). The manifold 26 may connect to one or more flowlines 28. In some embodiments, the surface platform 30 may include a floating production, storage, and offloading unit (FPSO) or a shore-based facility. In addition to flowlines 28 that carry the formation fluid away from the wells 22, the subsea system 10 may include a conduit 32 that carry production fluid (e.g., hydrocarbons, oil, natural gas, etc.) to the surface platform 30.

A conduit 32 is fluidly connected to the pump station 34, which is configured to pump the production fluid from the seabed 20 to the surface platform 30. In some scenarios, the platform 30 may be located a significant distance (e.g., greater than 100 m, greater than 1 km, greater than 10 km, or greater than 60 km) away from the wells 22. As discussed in further detail below, the subsea system 10 (e.g., the subsea tree 14, the subsea station 18, the manifold 26, and/or the pump station 34) may include one or more turbine power systems 36 (e.g., subsea turbine power systems) that provide primary power and/or secondary power over one or more buses to various subsea stations (e.g., actuators, sensors, controllers, pumps, compressors, valves, etc.). For example, the one or more turbine power systems 36 may be configured to provide secondary power, such as during a power loss from the primary power from the electrical cables 12, to operate various valves, sensors, pumps, compressors, controllers, and other subsea stations. While the subsea system 10 described above is for extracting hydrocarbons, it should be understood that the present disclosure may also apply to other types of subsea systems 10, such as subsea injection systems (e.g., subsea gas injection system, subsea water injection system, and/or subsea carbon dioxide injection system).

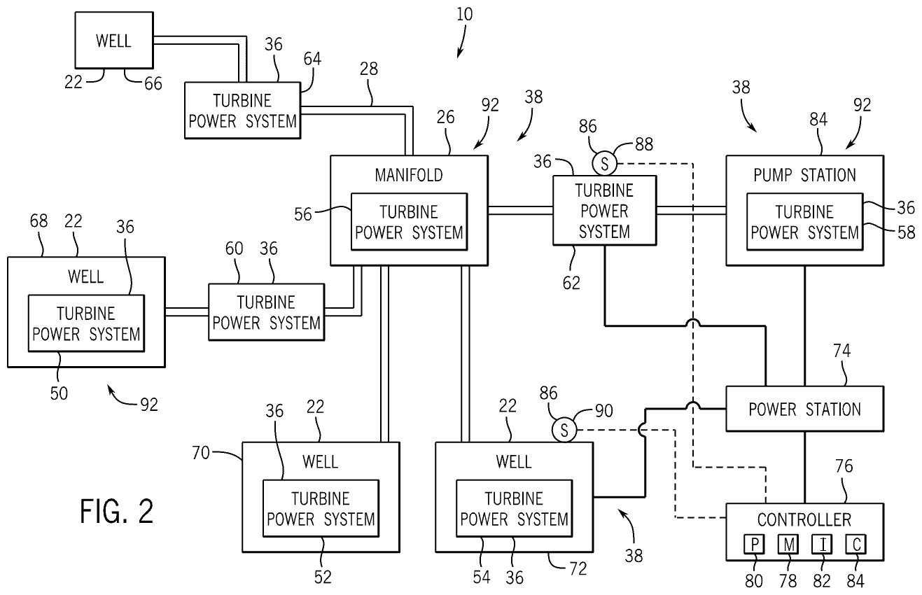

FIG. 2 is a schematic view of the subsea system 10 of FIG. 1 having one or more turbine power systems 36 (e.g., turbine power systems 50, 52, 54, 56, 58, 60, 62, and 64) coupled to various subsea equipment 38 of the subsea system 10. In the illustrated embodiment, the subsea system 10 includes one or more wells 22 (e.g., wells 66, 68, 70, and 72) fluidly coupled to the manifold 26. The manifold 26 is fluidly coupled to the pump station 34, which pumps the production fluid produced by the wells 22 to the surface platform. As shown, the subsea system 10 also includes a power station 74 that may receive power from the surface platform and/or one or more of the turbine power systems 36. Additionally or alternatively, the power station 58 may distribute power to the pump station 34, the manifold 26, hardware associated with the wells 22, and/or one or more of the turbine power systems 36.

The subsea system 10 also includes a controller 76. The controller 76 includes a memory 78, a processor 80, instructions 82 stored on the memory 78 and executed by the processor 80, and communication circuitry 84. The subsea system 10 also includes one or more sensors 86 (e.g., sensors 88, 90) coupled to hardware (e.g., trees, valves, blow-out preventers (BOPs), etc.) associated with the wells 22 and/or the turbine power systems 36, and communicatively coupled to the controller 76. The sensors 88 may include temperature sensors, pressure sensors, flow rate sensors, water content sensors, electrical load sensors, or a combination thereof. In certain embodiments, the sensors 86 may include additional sensors coupled to the manifold 26, the pump station 34, and/or the power station 74. In certain embodiments, the controller 76 may be communicatively coupled to the one or more turbine power systems 36, the manifold 26, the pump station 34, and/or hardware associated with the one or more wells 22.

While the illustrated embodiment shows four wells 22 and eight turbine power systems 36, it should be recognized that the subsea system 10 may include fewer or more wells 22 and/or turbine power systems 36. For example, the subsea system 10 may include 1, 2, 3, 5, 6, 7, 8, 9, 10, or more wells 22 and/or 1, 2, 3, 4, 5, 6, 7, 9, 10, or more turbine power systems 36. Additionally or alternatively, while the illustrated embodiment shows one manifold 26, one power station 74, and one controller 76, the subsea system 10 may include one or more manifolds 26, one or more power stations 74, and/or one or more controllers 76.

In the illustrated embodiment, the turbine power systems 36 are shown as being distributed at different locations throughout the subsea system 10. As shown, one or more of the turbine power systems 36 (e.g., turbine power systems 50, 52, 54, 56, 58) may be coupled to a subsea station 92 fluidly coupled to one or more of the flow lines 28. For example, the turbine power systems 50, 52, and 54 are coupled to subsea stations 92 (e.g., trees, blow-out preventers, etc.) that are coupled to the wells 22. Additionally or alternatively, the turbine power systems 36 may be coupled to the subsea station 92 located away from the wells 22. For example, the turbine power systems 56 and 58 are coupled to the manifold 26 and the pump station 34, respectively. Additionally or alternatively, the turbine power systems 36 may be coupled to the flow lines 28 (e.g., fluid conduits or pipes) as standalone systems. For example, the turbine power systems 60, 62, and 64 are shown as being fluidly coupled to the flow lines 28 as standalone units.

In certain embodiments, the turbine power systems 36 may be configured to retrievably couple to the manifold 26, the subsea station 92 associated with the wells 22, and/or the flow lines 28. That is, the turbine power system 36 may be a retrievable module that may be configured to be retrieved by a remotely operated vehicle (ROV) or another device. In other embodiments, the turbine power systems 36 may pre-installed in the subsea station 92 prior to installation of the hardware. Additionally or alternatively, the turbine power systems 36 may include standalone non-retrievable structures. It should be recognized that the turbine power systems 36 may include any combination of configurations described herein (e.g., retrievable, standalone, pre-installed, etc.).

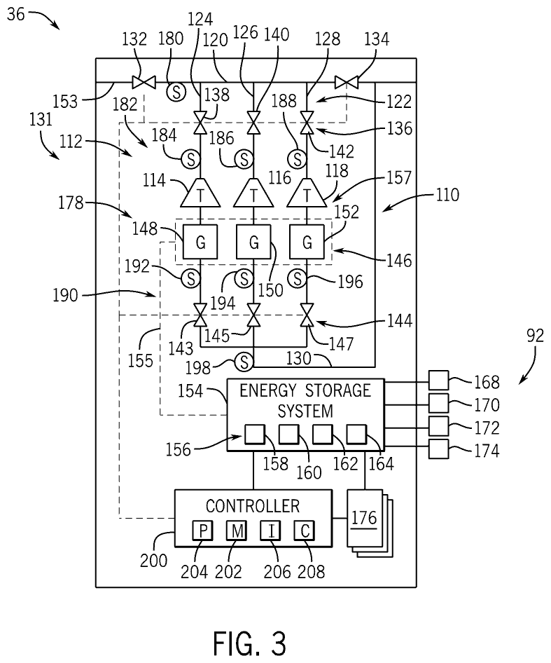

FIG. 3 is a schematic view of a turbine power plant 110 of the turbine power system 36 of FIG. 2. As shown, the turbine power plant 110 includes one or more turbo expanders or turbines 112 (e.g., turbines 114, 116, 118) fluidly coupled to an inlet fluid conduit or line 120, wherein each turbine 112 is driven by a pressurized fluid flow from the inlet line 120. As shown, the turbine power plant 110 also includes one or more branch fluid conduits or lines 122 (e.g., branch lines 124, 126, and 128) that are each fluidly coupled to the inlet line 120. As shown, the turbines 114, 116, and 118 are fluidly coupled to the branch lines 124, 126, and 128, respectively, in a parallel configuration. As shown, the one or more branch lines 122 merge into a feedback fluid conduit or line 130, which feeds fluid back and is fluidly coupled to the inlet line 120 at a location downstream of the branch line 128. In certain embodiments, there may be fewer or more than three branch lines 122. For example, there may be 1, 2, 4, 5, 6, 7, 8, or more branch lines 122.

In the illustrated embodiment, the turbine power plant 110 includes one or more valves 131 including an inlet valve 132, an allocation valve 134 (e.g., distribution valve), one or more turbine inlet valves 136 (e.g., turbine inlet valves 138, 140, and 142), one or more turbine outlet valves 144 (e.g., turbine outlet valves 143, 145, and 147), or a combination thereof. In certain embodiments, the one or more valves 131 may include the inlet valve 132, the allocation valve 134, the one or more turbine inlet valves 136, the one or more turbine outlet valves 144, or any combination thereof. In certain embodiments, the one or more valves 131 may include an adjustable variable flow control valve, a hydraulic actuated valve, an electrical actuated valve, or any combination thereof. In certain embodiments, there may be fewer or more than three turbine inlet valves 136 and/or turbine outlet valves 144. For example, the turbine inlet valves 136 may include 1, 2, 4, 5, 6, 7, 8, or more turbine inlet valves 136. Additionally or alternatively, the turbine inlet valves 144 may include 1, 2, 4, 5, 6, 7, 8, or more turbine inlet valves 144. It should be recognized that the one or more valves 131 may include fewer or more valves 131 in combination with each of the one or more valves 131 described herein.

The turbine power plant 110 also includes one or more electrical generators 146 (e.g., electrical generators 148, 150, and 152) directly coupled (e.g., rotatably coupled via shafts) to the one or more turbines 112. As shown, the generators 148, 150, and 152 are directly coupled to the turbines 114, 116, and 118, respectively. In the illustrated embodiment, the turbine power plant 110 includes three generators 146. In certain embodiments, the turbine power plant 110 may include fewer or more than three generators 146. For example, the turbine power plant 110 may include 1, 2, 4, 5, 6, 7, 8, or more generators 146. The turbine power plant 110 of the subsea turbine power system 36 is configured to receive potential energy (e.g., pressure energy) from a well fluid 153 (e.g., production fluid) received from the hydrocarbon well. Additionally, the turbine power plant 110 is configured to cause rotation of the one or more turbines 112 using the potential energy received from the well fluid 153, thereby converting a portion of the potential energy into mechanical energy. The one or more generators 146 are driven via the mechanical energy output by the one or more turbines 112 to generate electrical energy 155. In certain embodiments, a portion of the mechanical energy 157 (e.g., torque applied via a shaft) produced by the one or more turbines may be sent to the one or more generators 146 to produce the electrical energy 155. That is, in certain embodiments, the turbine power plant 110 may output the mechanical energy 157, the electrical energy 155, or a combination thereof.

The turbine power plant 110 also includes an energy storage system 154 electrically coupled to the one or more generators 146 of the turbine power plant 110. The energy storage system 154 includes one or more energy storage devices 156 (e.g., energy storage devices 158, 160, 162, 164). The energy storage devices 156 may include batteries, capacitors, or any combination thereof. In the illustrated embodiment, the energy storage system 154 includes four energy storage devices 156. In certain embodiments, the energy storage system 154 may include fewer or more energy storage devices 156. For example, the energy storage system 154 may include 1, 2, 3, 5, 6, 7, 8, or more energy storage devices 156. In the illustrated embodiment, the energy storage system 154 is electrically coupled to one or more subsea stations 92 (e.g., subsea stations 168, 170, 172, and 174 [subsea equipment]) and/or one or more other components 176 of the turbine power system 36. The one or more subsea stations 92 and/or the one or more other components 176 are at least partially powered by the electrical energy 155 and/or the mechanical energy 157 produced by the turbine power system 36. In certain embodiments, the one or more subsea stations 92 may include a valve (e.g., valves 131), a pump, a compressor, a controller (e.g., controller 76), a sensor, a tree, a manifold, or a combination thereof. As shown, the one or more subsea stations 92 are electrically coupled to the energy storage system 154.

In the illustrated embodiment, the turbine power plant 110 includes one or more sensors 178. In certain embodiments, the one or more sensors 178 may include the sensors 86 of the subsea system described herein. As shown, the one or more sensors 178 may include a main inlet sensor 180, one or more turbine inlet sensors 182 (e.g., turbine inlet sensors 184, 186, and 188) disposed upstream of the one or more turbines 112, one or more turbine outlet sensors 190 (e.g., turbine outlets sensors 192, 194, and 196) disposed downstream of the one or more turbines 112, a feedback line sensor 198 disposed on the feedback line 130, or a combination thereof. It should be recognized that the turbine power system may include fewer or more sensors 178 in combination with the one or more sensors 178 described herein. The sensors 178 (e.g., 180, 182, 184, 186, 188, 190, 192, 194, 196, and 198) may include pressure sensors, flow rate sensors, temperature sensors, fluid composition sensors, water content sensors, gas content sensors, or any combination thereof.

In the illustrated embodiment, the turbine power plant 110 also includes a controller 200. In certain embodiments, the controller 200 may include the controller 76 of the subsea system discussed herein or another suitable controller. The controller 200 includes a memory 202, a processor 204, instructions 206 stored on the memory 202 and executed by the processor 204, and communication circuitry 208. As shown, the controller 200 is communicatively coupled to the one or more valves 131, the energy storage system 154, and the components 176 of the turbine power system 36. In certain embodiments, the controller 200 may be communicatively coupled to any combination of the one or more valves 131, the energy storage system 154, the components 176, the turbines 112, the generators 146, the sensors 178, or a combination thereof.

In certain embodiments, the controller 200 is configured to control the valves 131 (e.g., 132, 134, 136, 138, 140, 142, 144, 143, 145, 147) to control fluid flow through each of the turbines 112 (e.g., turbines 114, 116, 118) to generate electricity via the respective electrical generators 146 (e.g., electrical generators 148, 150, and 152) in response to sensor feedback from the sensors 178. For example, if the sensors 178 indicate a pressure and/or a flow rate above one or more upper thresholds, then the controller 200 may selectively open one or more valves 131 to direct fluid flow through one or more of the turbines 112 (e.g., turbines 114, 116, 118) to generate electricity via the respective electrical generators 146 (e.g., electrical generators 148, 150, and 152). By further example, if the sensors 178 indicate a pressure and/or a flow rate below one or more lower thresholds, then the controller 200 may selectively close one or more valves 131 to stop fluid flow through one or more of the turbines 112 (e.g., turbines 114, 116, 118) to stop generating electricity via the respective electrical generators 146 (e.g., electrical generators 148, 150, and 152). The controller 200 may monitor sensor feedback relative to a minimum pressure and/or a minimum flow rate sufficient to flow the fluid (e.g., well fluid) from the subsea location to the surface location and/or other remote location, which may be based on a depth of seawater from the surface location to the subsea location, a length of the conduit horizontally and/or vertically, a diameter of the conduit, and/or physical properties of the fluid flow (e.g., fluid composition, viscosity, etc.). If the controller 200 determines that excess energy is available in the fluid flow (e.g., beyond the minimum pressure and/or minimum flow rate), then the controller 200 may selectively use that excess energy in the fluid flow by operating one or more of the turbines 112 (e.g., turbines 114, 116, 118) to generate electricity via the respective electrical generators 146 (e.g., electrical generators 148, 150, and 152). In certain embodiments, the controller 200 is configured to selectively control the plurality of valves 131 to independently control the flow of the well fluid through the plurality of turbines 112 based on the sensor feedback from sensors 178 to maintain the pressure and/or the flow rate between an upper threshold (e.g., upper pressure threshold and/or upper flow rate threshold) and a lower threshold (e.g., lower pressure threshold and/or lower flow rate threshold).

For example, in some scenarios, the excess energy in the fluid flow may be sufficient to operate all of the turbines 112 (e.g., turbines 114, 116, 118) at full capacity, and thus the controller 200 may selectively open the valves 132, 138, 140, 142, 143, 145, and 147 to enable the fluid flow to drive all of the turbines 112 (e.g., turbines 114, 116, 118) to generate electricity via the respective electrical generators 146 (e.g., electrical generators 148, 150, and 152). By further example, in some scenarios, the excess energy in the fluid flow may be sufficient to operate only one of the turbines 112 (e.g., turbine 114) at full capacity, and thus the controller 200 may selectively open the valves 132, 138, and 145 to enable the fluid flow to drive the turbine 112 (e.g., turbine 114) to generate electricity via the respective electrical generator 146 (e.g., electrical generators 148). Other scenarios may have sufficient excess energy in the fluid flow to drive any number (e.g., 1, 2, 3, 4, 5, or more) of the turbines 112 at full capacity, thereby driving the respective generators 146 to generate electricity. Other scenarios may have sufficient excess energy in the fluid flow to drive one or more of the turbines 112 at full capacity and/or partial capacity, thereby fully or partially driving the respective generators 146 to generate electricity. In each scenario, the controller 220 is response to sensor feedback from the sensors 178, minimum pressure and/or flow rate requirements for a particular fluid flow conduit and destination, and other operating considerations, and the controller 220 is configured to control the various valves 131 to selectively enable or disable flow through any of the turbines 112 in the parallel arrangement. Thus, the turbine power plant 110 is configured to generate local power (e.g., electricity) using any excess energy in the fluid flow (e.g., waste energy) while also regulating the pressure and/or flow rate of the fluid flow being routed through one or more fluid flow conduits.

In certain embodiments, the inlet valve 132 may be configured to receive a signal from the controller 200 to adjust an actuation assembly of the inlet valve 132, thereby adjusting a flow rate of the well fluid 153 entering the turbine power system 36. Additionally or alternatively, the allocation valve 134 may be configured to receive a signal from the controller 200 to adjust an actuation assembly of the allocation valve 134 to adjust an amount (e.g., proportion) of the well fluid 153 diverted to the turbine power plant 110. For example, if the allocation valve 134 is closed, all of the well fluid 153 that enters the turbine power system 36 may be diverted (e.g., allocated, dedicated) to the turbine power plant 110 for generating power.

In certain embodiments, the one or more turbine inlet valves 136 may be configured to receive one or more signals from the controller 200 to adjust a distribution of the well fluid 153 between the one or more turbines 112. In certain embodiments, each of the one or more turbines 112 may receive an equal proportion of the well fluid 153 from the inlet line 120. In certain embodiments, each of the one or more turbines 112 may receive an unequal proportion of the well fluid 153. For example, each of the one or more turbines 112 may receive more or less than 10, 20, 30, 40, 50, 60, 70, 80, or 90 percent of the total flow of the well fluid 153 from the inlet line 112. It should be recognized that the proportion of the well fluid 153 distributed to each of the one or more turbines 112 may be varied by an operator in response to a condition of at least one of the one or more turbines 112. For example, if one of the one or more turbines 112 needs repair, the corresponding turbine inlet valve 136 may be closed to enable repair of the turbine 112. In certain embodiments, the one or more turbine outlet valves 144 may be configured to receive one or more signals from the controller 200 to provide redundant control of the flow rate of the well fluid 153 through each of the one or more branch lines 122 and/or each of the one or more turbines 112.

In certain embodiments, the main inlet sensor 180 may be configured send the controller 200 a signal indicative of a flow rate of the well fluid 153 flowing in the inlet line 120. The controller 200 may be configured to determine an estimated flow rate of the well fluid 153 flowing in the inlet line 120 based on the received signal. In certain embodiments, the controller 200 may be configured to control the inlet valve 132 in response to the estimated flow rate of the well fluid 153 in the inlet line 120 exceeding a high threshold flow rate or falling below a low threshold flow rate. For example, in response to the flow rate of the well fluid 153 in the inlet line 120 exceeding the high threshold flow rate, the controller 200 may be configured to instruct inlet valve 132 to at least partially block (e.g., impede or shut off) the flow of well fluid 153 in the inlet line 120.

In certain embodiments, the controller 200 may be configured to determine an estimated power demand (e.g., amount of demanded power) corresponding to the one or more subsea stations 92. In certain embodiments, the controller 200 may be configured to control the allocation valve 134 in response to the determined estimated power demand of the one or more subsea stations 92 exceeding a high power demand threshold or falling below a low power demand threshold. For example, in response to the estimated power demand falling below a low power demand threshold, the controller 200 may be configured to instruct allocation valve 134 to at least partially block (e.g., impede, shut off) the flow of well fluid 153 through the allocation valve 134, thereby causing a higher proportion of the well fluid 153 to flow through the turbine power plant 110 to generate additional power.

In certain embodiments, the one or more turbine inlet sensors 182 may be configured send the controller 200 a signal indicative of a flow rate of the well fluid 153 flowing in each of the one or more branch lines 122 upstream of the one or more turbines 112. The controller 200 may be configured to determine an estimated flow rate of the well fluid 153 flowing through each of the branch lines 122 upstream of the one or more turbines 112 based on the received signal. In certain embodiments, the controller 200 may be configured to control any combination of the one or more turbine inlet valves 136 in response to the estimated flow rate of the well fluid 153 in the one or more of the one or more branch lines 122 upstream of the one or more turbines 112 exceeding a high threshold flow rate or falling below a low threshold flow rate. For example, in response to the flow rate of the well fluid 153 in one or more of the one or more branch lines 122 upstream of the one or more turbines 112 exceeding the high threshold flow rate, the controller 200 may be configured to one or more of the one or more turbine inlet valves 136 to at least partially block (e.g., impede or shut off) the flow of well fluid 153 in one or more of the one or more branch lines 122 upstream of the one or more turbines 112.

In certain embodiments, the one or more turbine outlet sensors 190 may be configured send the controller 200 a signal indicative of a flow rate of the well fluid 153 flowing in each of the one or more branch lines 122 downstream of the one or more turbines 112. The controller 200 may be configured to determine an estimated flow rate of the well fluid 153 flowing through each of the branch lines 122 downstream of the one or more turbines 112 based on the received signal. In certain embodiments, the controller 200 may be configured to control any combination of the one or more turbine outlet valves 144 in response to the estimated flow rate of the well fluid 153 in the one or more of the one or more branch lines 122 downstream of the one or more turbines 112 exceeding a high threshold flow rate or falling below a low threshold flow rate. For example, in response to the flow rate of the well fluid 153 in one or more of the one or more branch lines 122 downstream of the one or more turbines 112 exceeding the high threshold flow rate, the controller 200 may be configured to one or more of the one or more turbine outlet valves 144 to at least partially block (e.g., impede or shut off) the flow of well fluid 153 in one or more of the one or more branch lines 122 downstream of the one or more turbines 112.

In certain embodiments, the feedback line sensor 198 may be configured send the controller 200 a signal indicative of a flow rate of the well fluid 153 flowing in the feedback line 130. The controller 200 may be configured to determine an estimated flow rate of the well fluid 153 flowing through the feedback line 130 based on the received signal. In certain embodiments, the controller 200 may be configured to control any combination of the one or more turbine outlet valves 144 in response to the estimated flow rate of the well fluid 153 in the one or more of the one or more branch lines 122 downstream of the one or more turbines 112 exceeding a high threshold flow rate or falling below a low threshold flow rate. For example, in response to the flow rate of the well fluid 153 in one or more of the one or more branch lines 122 downstream of the one or more turbines 112 exceeding the high threshold flow rate, the controller 200 may be configured to one or more of the one or more turbine outlet valves 144 to at least partially block (e.g., impede or shut off) the flow of well fluid 153 in one or more of the one or more branch lines 122 downstream of the one or more turbines 112.

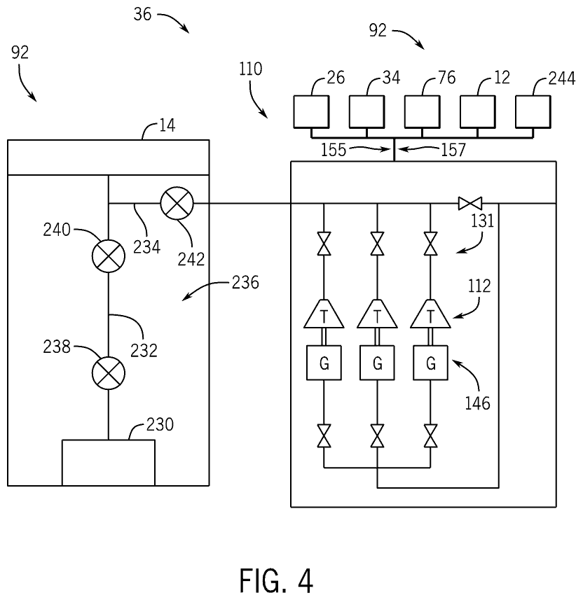

FIG. 4 is a schematic view of the turbine power system 36 of FIG. 2 as a standalone unit. The turbine power system 36 is substantially the same as described in detail above with reference to FIGS. 1-3. For example, the turbine power system 36 may include all of the components and functionality as described above with reference to FIG. 3, including the turbines 112, the electrical generators 146, the energy storage system 154, the controller 200, and the sensors 178. As shown, the turbine power system 36 is configured to fluidly couple to a subsea station 92, which may include the subsea tree 14, the manifold 26, the pump station 34, the controller 76, the field extensions, the electrical cables 12, and/or one or more additional components 244. For example, in the illustrated embodiment, the subsea station 92 includes the subsea tree 14 associated with a hydrocarbon well of the subsea system. The subsea tree 14 includes a well head 230, a main fluid flow path 232 fluidly coupled to the well head 230, and a branch fluid flow path 234 fluidly coupled to the main fluid flow path 232. As shown, the main fluid flow path 232 includes main valves 236 (e.g., main valves 238, 240) fluidly coupled to the main fluid flow path 232. The main valves 238, 240 may include a lower master valve and an upper master valve, respectively. Additionally, the subsea tree 14 includes a branch valve 242 (e.g., production wing valve) fluidly coupled to the branch fluid flow path 234. As shown, the turbine power system 36 is configured to fluidly couple to the branch fluid flow path 234 of the subsea tree 14. In the illustrated embodiment, the turbine power system 36 includes the turbine power plant 110 including the one or more turbines 112, the one or more valves 131, and the one or more generators 146 as described herein.

In the illustrated embodiment, the turbine power system 36 is configured to distribute the electrical energy 155 and/or the mechanical energy 157 produced by the turbine power plant 110 to the one or more subsea stations 92 (e.g., power consumers) of the subsea system 10. For example, the turbine power system 36 may be configured to transmit the electrical energy 155 to the manifold 26, the pump station 34, the controller 76, the field extensions, and/or the electrical cables 12 (e.g., umbilical cables). Additionally or alternatively, the turbine power system 36 may be configured to transfer the mechanical energy 157 (e.g., torque applied via a shaft) to one or more subsea stations 92 having moving parts, such as a compressor, a pump, and/or the pump station 34. In certain embodiments, the turbine power system 36 may be configured to transfer the electrical energy 155 and/or the mechanical energy 157 to one or more components 244 of the subsea tree 14.

It should be recognized that while the illustrated embodiment shows the turbine power system 36 fluidly coupled to a subsea tree 14, in certain embodiments, the turbine power system 36 may be configured to fluidly couple to another type of subsea station 92. For example, the turbine power system 36 may be configured to a subsea manifold, a pump station, and the like.

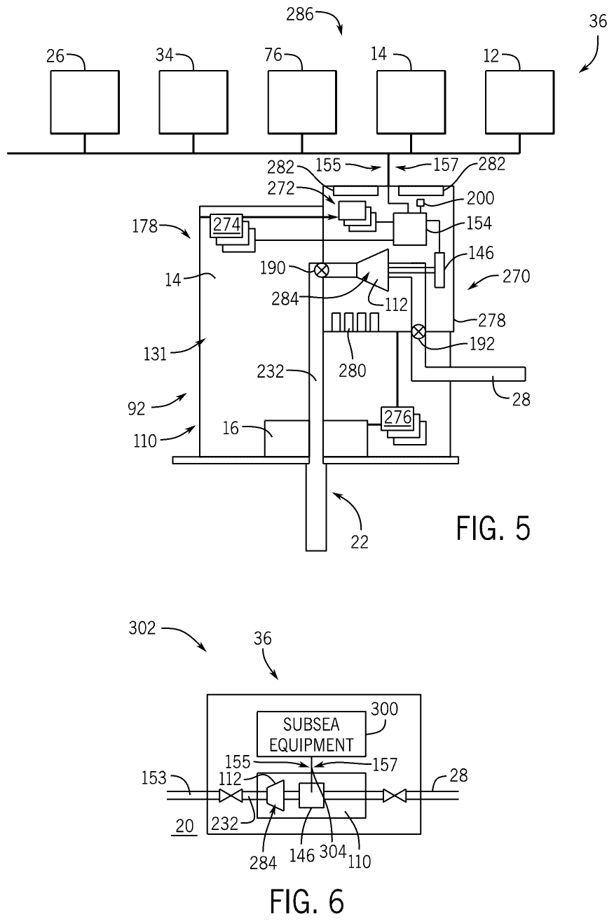

FIG. 5 is a schematic view of an embodiment of the turbine power system 36 of FIG. 2 retrievably coupled to a portion 270 (e.g., receptacle) of the main fluid flow path 232, wherein the main fluid flow path 232 couples to a flow line 28. The turbine power system 36 is substantially the same as described in detail above with reference to FIGS. 1-3. For example, the turbine power system 36 may include all of the components and functionality as described above with reference to FIG. 3, including the turbines 112, the electrical generators 146, the energy storage system 154, the controller 200, and the sensors 178. In the illustrated embodiment, the turbine power system 36 includes the turbine power plant 110, which may include a plurality of components 272 configured to convert energy (e.g., potential energy) of the fluid flow into power (e.g., electrical power and/or mechanical power). For example, as discussed in detail above with reference to FIG. 3, the components 272 may include the one or more turbines 112, the one or more generators 146, the one or more valves 131, the one or more sensors 178, the energy storage system 154, the controller 200, or a combination thereof. In certain embodiments, the turbine power system 36 is configured to generate power (e.g., electrical power and/or mechanical power) to operate various components coupled to and/or integrated within the subsea station 92, such as components 274 coupled to the subsea tree 14 and/or components 276 coupled to the wellhead 16.

As shown, the turbine power system 36 may have a retrievable housing 278 (e.g., retrievable process module (RPM)) that is retrievably coupled to the subsea station 92 (e.g., the subsea tree 14) at the portion 270, wherein the retrievable housing 278 and the portion 270 may include a plurality of releasable connections 280. The releasable connections 280 may include one or more of a mechanical connector, a fluid connector, an electrical connector, or any combination thereof. For example, the mechanical connector may include mating mechanical connectors, such as a hook and slot connector, clamps, threaded fasteners, rotating connectors, or any combination thereof. By further example, the electrical connectors may include one or more mating electrical connectors, such as male and female electrical connectors, which may connect and release via an axial push or pull, a rotational twist, a threaded connection, a hinged connection, or any combination thereof. By further example, the fluid connectors may include mating fluid connectors, such as male and female fluid connectors, which may connect and release via an axial push or pull, a rotational twist, a threaded connection, a hinged connection, or any combination thereof. In certain embodiments, the turbine power system 36 also may include ROV connectors 282, such that an ROV can connect to the ROV connectors 282 for installation or removal of the turbine power system 36. In certain embodiments, the ROV connectors 282 may include actuators to engage or release the various releasable connections 280. For example, the ROV may be configured to push, pull, rotate, or otherwise move at least one of the ROV connectors 282 to engage or release the various releasable connections 280.

In the illustrated embodiment, the subsea station 92 includes the subsea tree 14 coupled to the well 22 via the wellhead 16. In certain embodiments, the subsea station 92 may be located away from the well 22. For example, the subsea station 92 may include the manifold 26, the pump station 34, or a combination thereof. In certain embodiments, the manifold 26 may include a production fluid manifold configured to merge and/or redirect production fluid. Although the illustrated embodiment shows the turbine power system 36 being retrievable from the subsea station 92, in certain embodiments the turbine power system 36 may be pre-installed on the subsea station 92 as discussed herein.

In the illustrated embodiment, the turbine power system 36 is configured to receive potential energy 284 (e.g., pressure energy) from the production fluid (e.g., hydrocarbon fluid, such as oil, gas, etc.) flowing through the main fluid flow path 232. The turbine power system 36 is also configured to convert the potential energy 284 received from the production fluid into electrical energy 155 and/or mechanical energy 157 via the turbine power plant 110. In certain embodiments, the turbine power system 36 is coupled to the subsea station 92 of any type of well 22, including but not limited to hydrocarbon production wells (e.g., oil and/or gas wells), carbon capture and storage (CCS) wells, any combination thereof. However, regardless of the type of well 22, the turbine power plant 110 receives potential energy 284 from the fluid flow in and/or out of the wells 22.

In the illustrated embodiment, the turbine power system 36 is configured to distribute the electrical energy 155 and/or the mechanical energy 157 to one or more power consumers 286 (e.g., subsea stations) of the subsea system 10 and/or the components 274 and 276. For example, the one or more power consumers 286 may include the manifold 26, the pump station 34, the controller 76, an additional tree 14, the field extensions, and/or the electrical cables 12 (e.g., umbilical cables). Additionally or alternatively, the turbine power system 36 may be configured to transfer mechanical energy 157 to one or more power consumers 286 having moving parts, such as compressors, pumps, and/or the pump station 34.

In certain embodiments, the turbine power system 36 may be configured to couple to one or more valves and/or fluid flow paths of the subsea station 92. The subsea station 92 may be configured to internally re-route the production flow to flow into the turbine power system 36 via a first valve 190 and out of the turbine power system 36 via a second valve 192. Thus, the turbine power system 36 may be fluidly coupled to the main fluid flow path 232 or and/or any secondary fluid flow path through the subsea station 92. In either case, the turbine power system 36 is fluidly coupled to a fluid flow path of the subsea station 92, thereby enabling transfer of the potential energy 284 to the one or more turbines 112 to generate the electrical energy 155 and/or the mechanical energy 157.

FIG. 6 is a schematic view of an embodiment of the turbine power system 36 of FIG. 2 fluidly and mechanically coupled to a subsea equipment 300 as a packaged unit 302. The turbine power system 36 is substantially the same as described in detail above with reference to FIGS. 1-3. For example, the turbine power system 36 may include all of the components and functionality as described above with reference to FIG. 3, including the turbines 112, the electrical generators 146, the energy storage system 154, the controller 200, and the sensors 178. Accordingly, the packaged unit 302 may include all aspects of the turbine power system 36 as described above. As shown, the turbine power system 36 includes the turbine power plant 110 fluidly coupled to the main fluid flow path 232 and/or the flow line 28 carrying the well fluid 153. In certain embodiments, the turbine power plant 110 may be directly coupled or mounted to the subsea equipment 300, the turbine power plant 110 may be mounted in close proximity to the subsea equipment 300 (e.g., within equal to or less than 1, 2, 3, 4, or 5 meters from the subsea equipment 300), the turbine power plant 110 and the subsea equipment 300 may be mounted in a vertical stack one over another, and/or the turbine power plant 110 and the subsea equipment 300 may be mounted in horizontal side-by-side arrangement to define the packaged unit 302. Additionally, the packaged unit 302 may be mounted in situ at a particular subsea station, well, or other subsea equipment of the subsea system 10.

In certain embodiments, the turbine power plant 110 is configured to convert the received potential energy 284 into the electrical energy 155 via the generator 146 of the turbine power plant 110. The turbine power plant 110 may be configured to power the subsea equipment 300 using the electrical energy 155. For example, the turbine power plant 110 may transmit the electrical energy 155 to the subsea equipment 300 via one or more electrical wires (e.g., energy transmission 304). In some embodiments, the turbine power plant 110 may generate mechanical energy 157 via the one or more turbines 112 and may transmit the mechanical energy 157 to the subsea equipment 300 via a shaft and/or one or more gears (e.g., energy transmission 304) coupling the one or more turbines 112 with the subsea equipment 300. In certain embodiments, the turbine power plant 110 may transmit a combination of the electrical energy 155 and the mechanical energy 157 to the subsea equipment 300.

Although the illustrated embodiment shows the subsea equipment 300 as being proximate to the turbine power plant 110, in certain embodiments the subsea equipment 300 may be located away (e.g., disjoint) from the turbine power plant 110, while still being packaged together as the packaged unit 302. The packaged unit 302 may have a common housing, a common framework, a common base or skid, or any combination thereof, wherein the packaged unit 302 also may define a retrievable unit (e.g., retrievable by a ROV). As noted above, the packaged unit 302 may include all aspects of the turbine power system 36. Accordingly, the packaged unit 302 may include the turbine power plant 110, the energy storage system 154, one or more sensors 178, the controller 200, or any combination thereof, as described in FIGS. 4 and 5. It should be recognized that any component (e.g., the turbine power plant) disposed within the packaged unit 302 may be appropriately sized to fit within the packaged unit 302. In certain embodiments, the turbine power plant 110 and the subsea equipment 300 may be disposed in separate units removably coupled together. Additionally, although the illustrated embodiment shows the subsea equipment 300 contacting the seabed 20, in certain embodiments the subsea equipment 300 may not contact the seabed 20.

The subsea equipment 300 packaged with the turbine power system 36 in the packaged unit 302 may include one or more pumps, compressors, valves, blowout preventers (BOPs), controllers, sensors and monitoring equipment, safety equipment, communications equipment, or any combination thereof. The subsea equipment 300 may further include a subsea tree, a manifold, a subsea station, a wellhead, a chemical injection system, a fluid storage unit, an energy storage unit, or any combination thereof. Accordingly, the subsea equipment 300 may include a variety of subsea components packaged together with the turbine power system 36.

In certain embodiments, the turbine power system 36 may be configured to retrievably couple to the subsea equipment 300 in the packaged unit 302. That is, the turbine power system 36 may be a retrievable module (e.g., retrievable housing 278 as shown in FIG. 5) that may be configured to be retrieved by the ROV or another device relative to the packaged unit 302. In certain embodiments, the turbine power system 36 may pre-installed in and/or to the subsea equipment 300, such as within a housing or enclosure of the subsea equipment 300. In certain embodiments, a portion or subsystem of the turbine power system 36 may be retrievable while a main body of the turbine power system 36 remains in place relative to the packaged unit 302.

In certain embodiments, the turbine power plant 110, the subsea equipment 300, or a combination thereof, may be retrievable from a subsea structure. Additionally or alternatively, the turbine power system 36 may include standalone non-retrievable structures. It should be recognized that the turbine power system 36 may include any combination of configurations described herein (e.g., retrievable, standalone, pre-installed, etc.). Although the illustrated embodiment shows the turbine power system 36 having a single turbine power plant 110 and a single subsea equipment 300 packaged together in the packaged unit 302, the turbine power system 36 may have one or more turbine power plants 110 in order to maximize an amount of potential energy 284 received from the well fluid 153.

It should be recognized that the subsea system 10 may include any combination of the types of turbine power systems 36 discussed herein. That is, the subsea system 10 may include one or more turbine power systems 36 that retrievably couple to a subsea module (e.g., retrievable process modules), one or more turbine power systems 36 that include dedicated wells fluidly coupled to a turbine power plant 110, one or more turbine power systems 36 that include a turbine power plant 110 packaged with a subsea equipment 300, or any combination thereof.

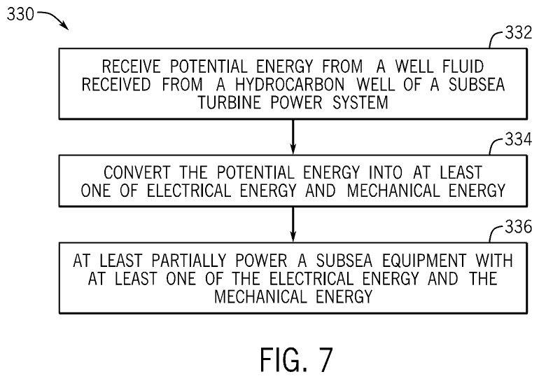

FIG. 7 is a flowchart of an example process for operating the turbine power system 36 of FIG. 2. The process 330 may be performed by a processor-based computing device or controller disclosed above with reference to FIG. 2 or any other suitable computing device(s) or controller(s). Furthermore, the blocks of the process 330 may be performed in the order disclosed herein or in any other suitable order. For example, certain blocks of the process 330 may be performed concurrently. In addition, in certain embodiments, at least one of the blocks of the process 330 may be omitted.

In block 332 of the process 330, a turbine power plant of the turbine power system receives potential energy (e.g., pressure energy) from a well fluid received from a hydrocarbon well in a subsea system. For example, the turbine power plant may receive the potential energy via receiving at least a portion of the pressurized well fluid extracted from one or more hydrocarbon wells in the subsea system.

In block 334 of the process 330, the turbine power plant converts the potential energy into at least one of electrical energy and mechanical energy. For example, in certain embodiments, converting the potential energy includes at least one of driving a turbine with the well fluid to generate the mechanical energy and driving an electrical generator with the turbine to generate the electrical energy.

In block 336 of the process 330, the turbine power system at least partially powers a subsea equipment with at least one of the electrical energy and the mechanical energy. For example, the turbine power system may power one or more trees (e.g., Christmas tree, frac tree, production tree, etc.) coupled to one or more wells throughout the field (e.g., a hydrocarbon field), one or more subsea stations, one or more pumps, one or more compressors, one or more valves, one or more manifolds, one or more field extensions, one or more controllers, one or more pump stations, one or more umbilical cords, or a combination thereof.

In certain embodiments, a processor of the turbine power system may receive a signal from one or more sensors indicative of a flow rate of the well fluid flowing through the plurality of turbines. The processor may determine an estimated flow rate based on the received signal. The processor may instruct (e.g., control) one or more valves to adjust the flow rate of the well fluid based on the estimated flow rate. For example, the processor may instruct the one or more valves to adjust the flow rate based on the estimated flow rate falling below a low threshold flow rate or exceeding a high threshold flow rate.

Technical effects of the disclosed embodiments include one or more turbine power systems 36 that are distributed throughout a subsea system 10 that may be used to produce power (e.g., local power at a subsea location) that may be utilized by the subsea system and/or a surface platform. In particular, the disclosed embodiments may be used for powering one or more subsea equipment 300, including but not limited to trees coupled to one or more wells throughout the field, one or more field extensions, the controller, the pump station, the manifold, subsea boosting, subsea compression, pipe heating, or a combination thereof. In certain embodiments, power produced by the one or more turbine power systems 36 may be sent to a surface platform via an electrical cable (e.g., umbilical cable). It may appreciated that a turbine power system 36 may produce sufficient power to eliminate the three phase power cable portion of the electrical cables connecting the surface platform, thereby reducing the manufacturing cost of the electrical cable. A turbine power system 36 may also eliminate the traditional fuel (e.g., diesel fuel) that may be used for powering subsea equipment. Additionally, the one or more turbine power systems 36 may be able to mitigate the chance of losing power due to a loss of power transmission through the electrical cable. The use of one or more turbine power systems 36 disposed throughout the subsea system 10 also produces zero carbon emissions, thereby offsetting and potentially reducing the amount of carbon emissions produced for powering various stations of the subsea system 10.

The subject matter described in detail above may be defined by one or more clauses, as set forth below.

A system includes a subsea turbine power system having a turbine power plant configured to receive potential energy from a well fluid received from a hydrocarbon well, and convert the potential energy into at least one of electrical energy and mechanical energy. The system further includes a subsea equipment at least partially powered by at least one of the electrical energy and the mechanical energy produced by the subsea turbine power system. The system further includes at least one valve configured to control flow of the well fluid through the turbine power plant. The system further includes a sensor configured to obtain sensor feedback of a pressure and/or a flow rate of the well fluid. The system further includes a controller having a processor, a memory, and instructions stored on the memory and executable by the processor to adjust the at least one valve to control the flow of the well fluid through the turbine power plant.

The system of the preceding clause, wherein the subsea equipment includes a valve, a pump, a compressor, a controller, a sensor, a tree, a manifold, or any combination thereof.

The system of any preceding clause, wherein the subsea turbine power system is directly coupled to the subsea equipment.

The system of any preceding clause, further including a retrievable module configured to be retrieved by a remotely operated vehicle (ROV), wherein the retrievable module includes at least the turbine power plant of the subsea turbine power system.

The system of any preceding clause, wherein the retrievable module is removably coupled to a portion of a tree.

The system of any preceding clause, further including a standalone module configured to fluidly couple to a tree associated with the hydrocarbon well, wherein the standalone module includes the subsea turbine power system.

The system of any preceding clause, wherein the subsea equipment is at least partially powered by the mechanical energy produced by the subsea turbine power system.

The system of any preceding clause, wherein the subsea equipment is at least partially powered by the electrical energy produced by the subsea turbine power system, wherein the subsea turbine power system includes one or more electrical generators driven by one or more turbines to generate the electrical energy.

The system of any preceding clause, wherein the turbine power plant includes a plurality of turbine driven electrical generators, each having an electrical generator driven by a turbine, wherein the plurality of turbine driven electrical generators is fluidly coupled in a parallel arrangement.

The system of any preceding clause, wherein the at least one valve includes a plurality of valves configured to independently control the flow of the well fluid through the plurality of turbine driven electrical generators.

The system of any preceding clause, wherein the controller is further configured to selectively control the plurality of valves to independently control the flow of the well fluid through the plurality of turbine driven electrical generators based on the sensor feedback to maintain the pressure and/or the flow rate between an upper threshold and a lower threshold.

The system of any preceding clause, wherein the subsea turbine power system includes an energy storage system including one or more energy storage units, wherein the energy storage system is configured to receive power from the turbine power plant.

A system includes a subsea turbine power system having a turbine power plant configured to receive potential energy from a well fluid received from a hydrocarbon well and convert the potential energy into at least one of electrical energy and mechanical energy, the turbine power plant including a plurality of turbines. The turbine power plant further includes a controller including a processor, a memory, and instructions stored on the memory and executable by the processor to control a distribution of the well fluid to the plurality of turbines.

The system of the preceding clause, wherein the subsea turbine power system includes one or more sensors configured obtain sensor feedback of a pressure and/or a flow rate of the well fluid, and a plurality of valves configured to independently control flow of the well fluid flowing through the plurality of turbines in response to control by the controller based on the sensor feedback.

The system of any preceding clause, wherein the controller is configured to selectively control the plurality of valves to independently control the flow of the well fluid through the plurality of turbines based on the sensor feedback to maintain the pressure and/or the flow rate between an upper threshold and a lower threshold.

The system of any preceding clause, wherein the plurality of turbines is fluidly coupled in a parallel arrangement, and the plurality of turbines includes at least three turbines.

The system of any preceding clause, further including a plurality of electrical generators each driven by one of the plurality of turbines to generate electrical energy.

A method includes receiving potential energy from a well fluid received from a hydrocarbon well. The method further includes converting the potential energy into at least one of electrical energy and mechanical energy in a turbine power plant of a subsea turbine power system. The method further includes at least partially powering a subsea equipment with at least one of the electrical energy and the mechanical energy.

The method of any preceding clause, wherein converting the potential energy further includes independently controlling a flow of the well fluid through a plurality of turbines of the turbine power plant, wherein the plurality of turbines is fluidly coupled in a parallel arrangement.

The method of any preceding clause, further including obtaining sensor feedback of a pressure and/or a flow rate of the well fluid. The method further includes adjusting at least one valve to control a flow of the well fluid through the turbine power plant based on the sensor feedback to maintain the pressure and/or the flow rate between an upper threshold and a lower threshold.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A system comprising:
a subsea turbine power system comprising a turbine power plant configured to receive potential energy from a well fluid received from a hydrocarbon well and convert the potential energy into at least one of electrical energy and mechanical energy;
a subsea equipment at least partially powered by at least one of the electrical energy and the mechanical energy produced by the subsea turbine power system;
at least one valve configured to control flow of the well fluid through the turbine power plant;
a sensor configured to:
obtain sensor feedback of a pressure of the well fluid;
obtain sensor feedback of a flow rate of the well fluid;
or a combination thereof; and
a controller having a processor, a memory, and instructions stored on the memory and executable by the processor to adjust the at least one valve to control the flow of the well fluid through the turbine power plant.

2. The system of claim 1, wherein the subsea equipment comprises a valve, a pump, a compressor, a controller, a sensor, a tree, a manifold, or any combination thereof.

3. The system of claim 1, wherein the subsea turbine power system is directly coupled to the subsea equipment.

4. The system of claim 1, further comprising a retrievable module configured to be retrieved by a remotely operated vehicle (ROV), wherein the retrievable module comprises at least the turbine power plant of the subsea turbine power system.

5. The system of claim 4, wherein the retrievable module is removably coupled to a portion of a tree.

6. The system of claim 1, further comprising a standalone module configured to fluidly couple to a tree associated with the hydrocarbon well, wherein the standalone module comprises the subsea turbine power system.

7. The system of claim 1, wherein the subsea equipment is at least partially powered by the mechanical energy produced by the subsea turbine power system.

8. The system of claim 1, wherein the subsea equipment is at least partially powered by the electrical energy produced by the subsea turbine power system, wherein the subsea turbine power system comprises one or more electrical generators driven by one or more turbines to generate the electrical energy.

9. The system of claim 1, wherein the turbine power plant comprises a plurality of turbine driven electrical generators, each having an electrical generator driven by a turbine, wherein the plurality of turbine driven electrical generators is fluidly coupled in a parallel arrangement.

10. The system of claim 9, wherein the at least one valve comprises a plurality of valves configured to independently control the flow of the well fluid through the plurality of turbine driven electrical generators.

11. The system of claim 10, wherein the controller is further configured to selectively control the plurality of valves to independently control the flow of the well fluid through the plurality of turbine driven electrical generators based on the sensor feedback to:
maintain the pressure between a lower pressure threshold and an upper pressure threshold;
maintain the flow rate between a lower flow rate threshold and an upper flow rate threshold;
or a combination thereof.

12. The system of claim 1, wherein the subsea turbine power system comprises an energy storage system comprising one or more energy storage units, wherein the energy storage system is configured to receive power from the turbine power plant.

13. A system comprising:
a subsea turbine power system comprising:
a turbine power plant configured to receive potential energy from a well fluid received from a hydrocarbon well and convert the potential energy into at least one of electrical energy and mechanical energy, the turbine power plant comprising a plurality of turbines; and
a controller comprising a processor, a memory, and instructions stored on the memory and executable by the processor to control a distribution of the well fluid to the plurality of turbines.

14. The system of claim 13, wherein the subsea turbine power system further comprises:
one or more sensors configured to obtain sensor feedback of a pressure and/or a flow rate of the well fluid; and
a plurality of valves configured to independently control flow of the well fluid flowing through the plurality of turbines in response to a command by the controller based on the sensor feedback.

15. The system of claim 14, wherein the controller is configured to selectively control the plurality of valves to independently control the flow of the well fluid through the plurality of turbines based on the sensor feedback to:
maintain the pressure between a lower pressure threshold and an upper pressure threshold;
maintain the flow rate between a lower flow rate threshold and an upper flow rate threshold;
or a combination thereof.

16. The system of claim 13, wherein the plurality of turbines is fluidly coupled in a parallel arrangement, and the plurality of turbines includes at least three turbines.

17. The system of claim 16, further comprising a plurality of electrical generators each driven by a respective one of the plurality of turbines to generate electrical energy.

18. A method comprising:
receiving potential energy from a well fluid received from a hydrocarbon well;
converting the potential energy into at least one of electrical energy and mechanical energy in a turbine power plant of a subsea turbine power system; and
at least partially powering a subsea equipment with at least one of the electrical energy and the mechanical energy.

19. The method of claim 18, wherein converting the potential energy further comprises independently controlling a flow of the well fluid through a plurality of turbines of the turbine power plant, wherein the plurality of turbines is fluidly coupled in a parallel arrangement.

20. The method of claim 18, further comprising:
obtaining sensor feedback of a pressure and/or a flow rate of the well fluid; and
adjusting at least one valve to control a flow of the well fluid through the turbine power plant based on the sensor feedback to:
maintain the pressure between a lower pressure threshold and an upper pressure threshold;
maintain the flow rate between a lower flow rate threshold and an upper flow rate threshold;
or a combination thereof.
